(19) United States
(12) Patent Application Publication
(10) Pub. No.: US 2012/0026586 A1
(43) Pub. Date: Feb. 2, 2012

(54) DISPLAY DEVICE AND PHASE RETARDATION FILM

(75) Inventor: SHENG-CHANG CHEN, Miao-Li County (TW)

(73) Assignee: CHIMEI INNOLUX CORPORATION, Miao-Li County (TW)

(21) Appl. No.: 13/178,509

(22) Filed: Jul. 8, 2011

(30) Foreign Application Priority Data
Aug. 2, 2010 (CN) 201010242438.2

(51) Int. Cl. G02B 27/28

(52) U.S. Cl. 359/486.02

(57) ABSTRACT

A display device and a phase retardation film are provided. The display device includes a display module and a phase retardation layer disposed at the display module. The display module has sub-pixel regions arranged into an array along a first direction and a perpendicular second direction. The phase retardation layer has stripe-shaped first regions and second regions. The first regions and the second regions are parallel to each other and alternatively arranged. A long axis of one first region forms an acute angle with the first direction. The first regions and the second regions allow lights in different polarization states to pass through. The phase retardation film is a rectangle and has stripe-shaped first regions and second regions. The first regions and the second regions are parallel to each other and alternatively arranged. A long axis of one first region forms an acute angle with one side of the rectangle.

### BACKGROUND

1. Technical Field

The disclosure generally relates to a display device and a phase retardation film, and more particularly, to a display device for displaying stereoscopic images and a phase retardation film.

2. Description of Related Art

Along with the development of technologies, besides having small sizes and light weights, display devices are desired to display stereoscopic images. Generally speaking, to display a stereoscopic image, two different images are respectively presented to the left and right eye of a viewer so that a stereoscopic image is constructed inside the viewer's brain. For example, the left-eye image is presented in a vertical linear polarization state, and the right-eye image is presented in a horizontal linear polarization state. The viewer can respectively receive the left-eye image and the right-eye image through his/her left and right eyes by wearing a polarized glass in the perpendicular direction and a polarized glass in the horizontal direction respectively on his/her left and right eyes, so that a stereoscopic image can be constructed within the viewer's brain.

FIG. 1 is a partial view of a typical stereoscopic display device. Referring to FIG. 1, the display device 100 has an array of sub-pixel regions 110. There is a first phase retardation area 120 before a part of the sub-pixel regions 110 such that the left-eye image displayed by these sub-pixel regions 110 is presented in a first polarization state. There is a second phase retardation area 130 in front of the rest sub-pixel regions 110 such that the right-eye image displayed by these sub-pixel regions 110 is presented in a second polarization state. The left-eye glass worn by the viewer allows light in the first polarization state to pass through, and the right-eye glass worn by the viewer allows light in the second polarization state to pass through. Thus, the left-eye image and the right-eye image can successfully enter the viewer's left and right eyes and construct a stereoscopic image in the viewer's brain.

However, when the viewer looks at the display device 100 from a side viewing angle, the left-eye image displayed by the sub-pixel regions 110A may pass through the second phase retardation area 130 and enter the viewer's right eye in the second polarization state, or the right-eye image displayed by the sub-pixel regions 110B may pass through the first phase retardation area 120 and enter the viewer's left eye in the first polarization state. Namely, image distortion may be produced at the intersection C between the first phase retardation area 120 and the second phase retardation area 130. Typically, a light shielding area is disposed between the first phase retardation area 120 and the second phase retardation area 130 in order to resolve the image distortion problem at side viewing angles. However, this may sacrifice the aperture ratio and accordingly cause the display brightness to be insufficient.

### SUMMARY OF THE DISCLOSURE

According to an embodiment of the disclosure, a display device including a display module and a phase retardation layer is provided. The display module has a plurality of sub-pixel regions. The sub-pixel regions are arranged into an array along a first direction and a second direction, and the first direction is perpendicular to the second direction. The phase retardation layer is disposed at the display module. The phase retardation layer has a plurality of stripe-shaped first regions and a plurality of stripe-shaped second regions. The first regions and the second regions are parallel to each other and are alternatively arranged. A long axis of one of the first regions forms an acute angle with the first direction. The first regions and the second regions allow lights in different polarization states to pass through.

According to an embodiment of the disclosure, the phase retardation film presents a rectangular shape and has a plurality of stripe-shaped first regions and a plurality of stripe-shaped second regions. The first regions and the second regions are parallel to each other and are alternatively arranged. A long axis of one of the first regions forms an acute angle with one side of the rectangle. The first regions and the second regions allow lights in different polarization states to pass through.

These and other exemplary embodiments, features, aspects, and advantages of the disclosure will be described and become more apparent from the detailed description of exemplary embodiments when read in conjunction with accompanying drawings.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a partial view of a typical stereoscopic display device.

FIG. 2 is a partial view of a display device according to an embodiment of the disclosure.

FIG. 3 illustrates the relative position between the display device in FIG. 2 and a user.

FIG. 4 is a partial view of an active device array substrate of the display device in FIG. 2.

FIG. 5 illustrates how the display device in FIG. 2 displays a stereoscopic image.

FIGS. 6A-6C are flowcharts illustrating the fabrication of a phase retardation film according to an embodiment of the disclosure.

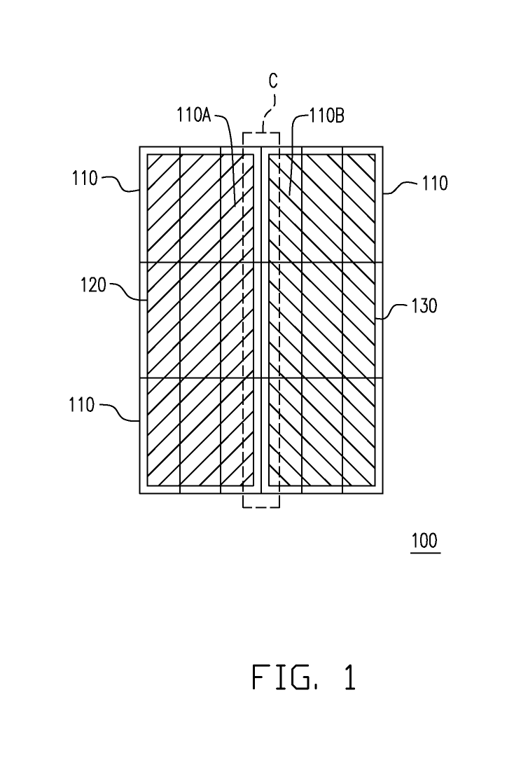

### DETAILED DESCRIPTION

Reference will now be made in detail to the present preferred embodiments of the disclosure, examples of which are illustrated in the accompanying drawings. Wherever possible, the same reference numbers are used in the drawings and the description to refer to the same or like parts.

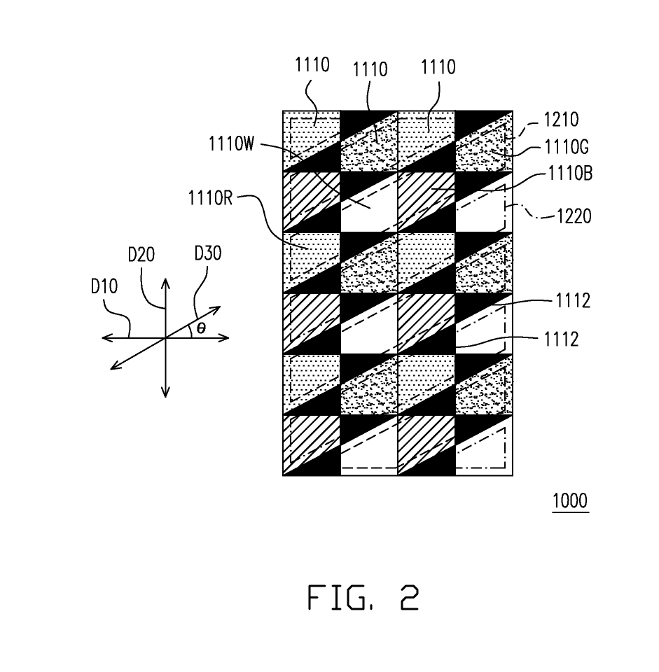

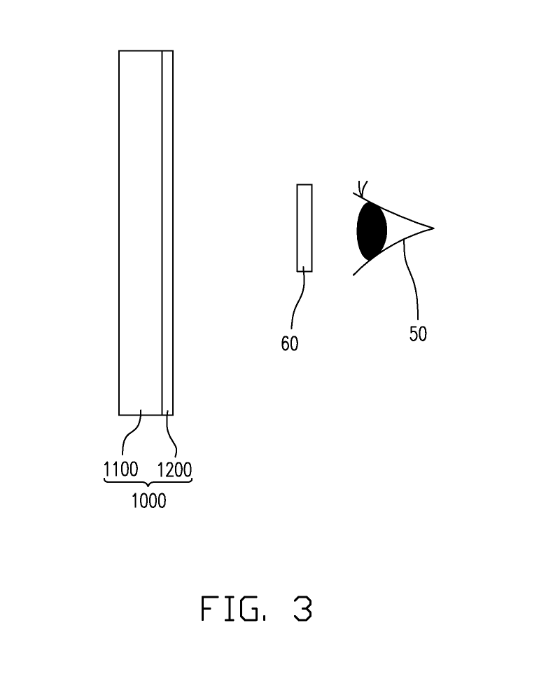

FIG. 2 is a partial view of a display device according to an embodiment of the disclosure, and FIG. 3 illustrates the relative position between the display device in FIG. 2 and a user. Referring to FIG. 2 and FIG. 3, the display device 1000 in the present embodiment includes a display module 1100 and a phase retardation layer 1200. The display module 1100 has a plurality of sub-pixel regions 1110. The sub-pixel regions 1110 are arranged into an array along a first direction D10 and a second direction D20, and the first direction D10 is perpendicular to the second direction D20. The phase retardation layer 1200 is disposed at the display module 1100. To be specific, the phase retardation layer 1200 is located between the display module 1100 and a user 50 so that before an image displayed by the display module 1100 enters the eyes of the user 50, the image is modulated by the phase retardation layer 1200 to correctly pass through a left-eye glass or a right-eye glass of a pair of glasses 60 worn by the user 50 and then enters the left eye or right eye of the user 50 to construct a stereoscopic image.

The phase retardation layer 1200 has a plurality of stripe-shaped first regions 1210 and a plurality of stripe-shaped second regions 1220. The first regions 1210 and the second regions 1220 are parallel to each other and are alternatively arranged. Namely, two second regions 1220 are respectively located at two sides of a first region 1210, and two first regions 1210 are respectively located at two sides of a second region 1220. A long axis D30 of one of the first regions 1210 forms an acute angle θ with the first direction D10, and the first regions 1210 and the second regions 1220 allow lights in different polarization states to pass through.

In the present embodiment, each sub-pixel region 1110 is assumed to be a square. However, each sub-pixel region 1110 may also present a rectangular shape or any other suitable shape. Additionally, in the present embodiment, four sub-pixel regions 1110 constitute a complete pixel region. The sub-pixel regions 1110 can be categorized into red sub-pixel regions 1110R, green sub-pixel regions 1110G, blue sub-pixel regions 1110B, and white sub-pixel regions 1110W. The display brightness of the display device 1000 can be improved by increasing the number of white sub-pixel regions 1110W. As shown in FIG. 2, in the present embodiment, most of the first regions 1210 and the second regions 1220 of the phase retardation layer 1200 present a stripe shape, but the first regions 1210 or second regions 1220 located at the corners present a triangular shape. In addition, the acute angle θ formed by the long axis D30 of a stripe-shaped first region 1210 and the first direction D10 is between 10° and 45°.

The design in the present embodiment offers the largest aperture ratio when the acute angle θ is tan⁻¹(1/2). However, the disclosure is not limited thereto. In the present embodiment, the phase retardation difference between the first regions 1210 and the second regions 1220 is π/2. Namely, after lights in the same linear polarization state pass through the first regions 1210 and the second regions 1220, the linear polarization directions thereof form an angle of π/2. In the present embodiment, it is assumed that the lights passing through the first regions 1210 and the second regions 1220 are in linear polarization states. However, in other embodiments, the lights passing through the first regions 1210 and the second regions 1220 may also be in circular polarization states. It is within the scope of the disclosure as long as the lights passing through the first regions 1210 and the second regions 1220 are in different polarization states therefore respectively pass through the left-eye glass and the right-eye glass of the glasses 60 worn by the user 50.

In the present embodiment, no black matrix is disposed between the first regions 1210 and the second regions 1220 of the phase retardation layer 1200 so that the aperture ratio of the display device 1000 won't be affected. In addition, in the present embodiment, the phase retardation layer 1200 is an individual film attached to the surface of the display module 1100. However, in other embodiments, the phase retardation layer 1200 may also be directly fabricated on the surface of or inside the display module 1100.

In the present embodiment, each sub-pixel region 1110 has overlap regions with the first regions 1210 and the second regions 1220, and a smaller one of the overlap regions between each sub-pixel region 1110 and the first regions 1210 and the second regions 1220 is a triangular region 1112, and the triangular region 1112 is opaque. Referring to FIG. 2, with such a design, the green sub-pixel regions 1110G and the white sub-pixel regions 1110W of the first regions 1210 are all corresponding to the first regions 1210 in the horizontal direction. Thus, image distortion at side viewing angles is avoided. Referring to FIG. 2, the white sub-pixel regions 1110W of the first regions 1210 and the green sub-pixel regions 1110G of the second regions 1220 belong to different phase retardation areas. However, because the opaque triangular region 1112 is disposed at the overlapped areas between the white sub-pixel regions 1110W and the second regions 1220, the situation of sub-pixel regions of a same color crossing over two different phase retardation areas (i.e., the first regions 1210 and the second regions 1220), and accordingly image distortion at side viewing angles, is avoided.

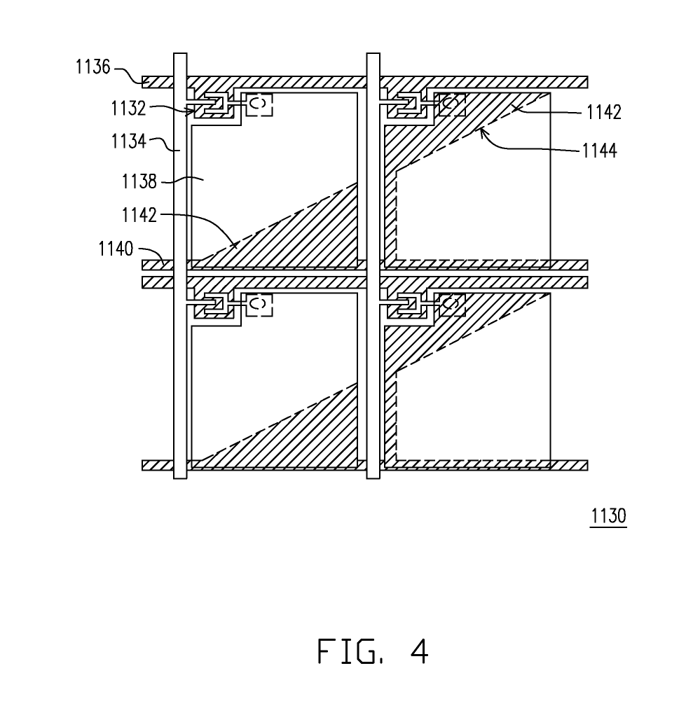

FIG. 4 is a partial view of an active device array substrate of the display device in FIG. 2. Referring to FIG. 3 and FIG. 4, in the present embodiment, the display module 1100 is a liquid crystal display (LCD) module. However, in other embodiments, the display module may also be an organic electro-luminescence device (OELD) panel, a plasma display panel, an electrophoresis display module, or any other display module as long as it has a plurality of sub-pixel regions arranged into an array. In the present embodiment, the display module 1100 has an active device array substrate 1130. The active device array substrate 1130 has a plurality of active devices 1132, a plurality of data lines 1134, a plurality of scan lines 1136, a plurality of pixel electrodes 1138, and a plurality of common lines 1140. Each active device 1132 is driven by a corresponding data line 1134 and a corresponding scan line 1136, and each active device 1132 is electrically connected to a pixel electrode 1138. Each common line 1140 has a triangular-shaped block 1142 at each triangular region 1112 in FIG. 2, and each block 1142 and the pixel electrode 1138 above the block 1142 constitute a pixel storage capacitor 1144. In other words, a pixel storage capacitor 1144 as shown in FIG. 4 can be disposed at each triangular region 1112 in FIG. 2. The pixel storage capacitors 1144 are essential devices to certain active device array substrate 1130, and the blocks 1142 of the common lines 1140 constituting the pixel storage capacitors 1144 are made of an opaque metal material. Thus, in the present embodiment, besides resolving the problem of image distortion at side viewing angles in the display module 1100 by adopting the design of the triangular region 1112, the maximum aperture ratio is also achieved, so as to improve the display brightness, by providing regions for disposing the pixel storage capacitors 1144.

In the embodiment described above, the triangular region 1112 is made opaque by disposing the pixel storage capacitors 1144. However, the triangular region 1112 may also be made opaque by covering a typical black matrix layer or through other techniques.

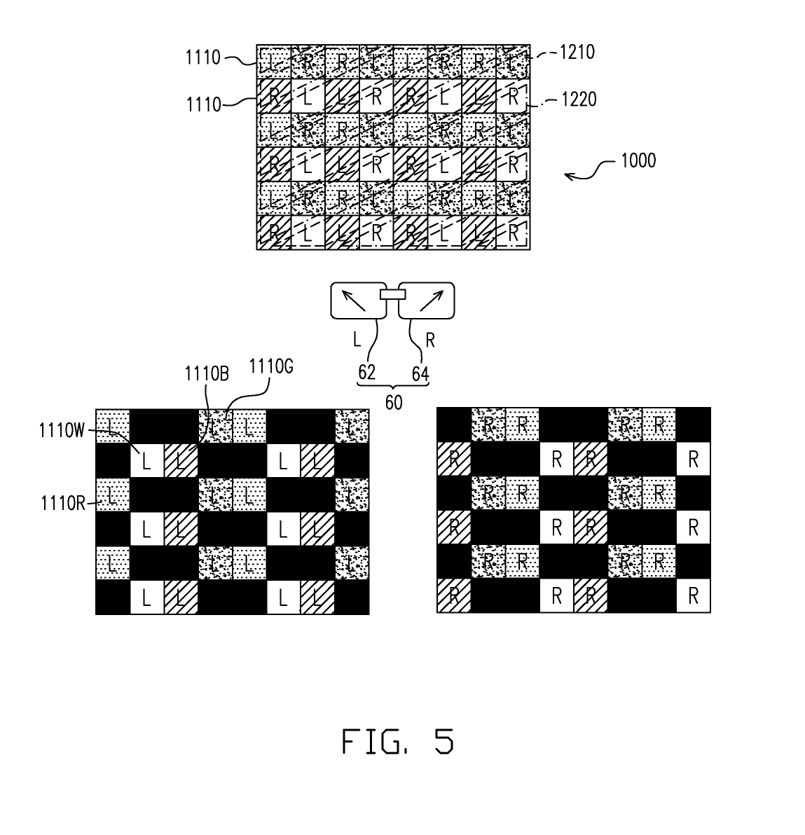

FIG. 5 illustrates how the display device in FIG. 2 displays a stereoscopic image. Referring to FIG. 5, each sub-pixel region 1110 is marked with symbol R or L to indicate whether the sub-pixel region 1110 displays the right-eye image or the left-eye image. As shown in FIG. 5, the sub-pixel regions 1110 corresponding to the first regions 1210 of the phase retardation layer 1200 display the left-eye image, while the sub-pixel regions 1110 corresponding to the second regions 1220 display the right-eye image. Because the left-eye image displayed by the sub-pixel regions 1110 passes through the left-eye glass 62 of the glasses 60 worn by the user and the right-eye image displayed by the sub-pixel regions 1110 cannot pass through the left-eye glass 62 of the glasses 60 worn by the user, the user cannot see the bottom left image in FIG. 5 through his left eye. Similarly, the user can see the bottom right image (which passes through the right-eye glass 64) in FIG. 5 through his right eye. The images presented to both eyes of the user constitute a stereoscopic image in the user's brain.

Additionally, image signals provided by an image source (for example a computer) are usually transmitted in a format adapted to red, green, and blue colors. When the image signals are displayed as a stereoscopic image by the display device 1000, the image signals are first converted into red, green, blue, and white signals through calculations, sorted according to whether they belong to the left-eye image or the right-eye image, and then sequentially sent to the sub-pixel regions 1110 to achieve the image distribution pattern as shown in FIG. 5, so as to display the stereoscopic image. When the display device 1000 displays a 2D image, the image signals transmitted in the format adapted to red, green, and blue colors are simply converted into red, green, blue, and white signals through calculations and sent to the corresponding sub-pixel regions 1110, and the user can take off the glasses 60 and directly look at the display device 1000 to see the 2D image.

In the display device 1000 of the present embodiment, four sub-pixel regions 1110R, 1110G, 1110B, and 1110W which have a width of four sub-pixel regions 1110 in the horizontal direction and a width of three sub-pixel regions 1110 in the vertical direction constitute a complete pixel region. Thus, the display resolution won't be reduced too much when the display device 1000 displays stereoscopic images. Taking a 65″ display device having 1920×1080 pixel regions as an example, if the user is 4.12 meters away from the display device, the horizontal viewing angle width of a complete pixel region captured by the user is 0.01°, and the vertical viewing angle width thereof is 0.008°. Both the horizontal viewing angle width and the vertical viewing angle width are smaller than the minimum viewing angle width 0.016° between two objects recognizable to human eyes. Thereby, the design in the present embodiment can present stereoscopic images having optimal resolution to the user.

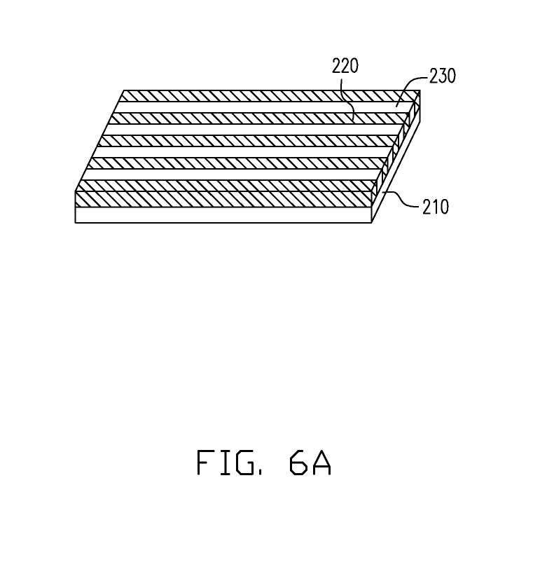

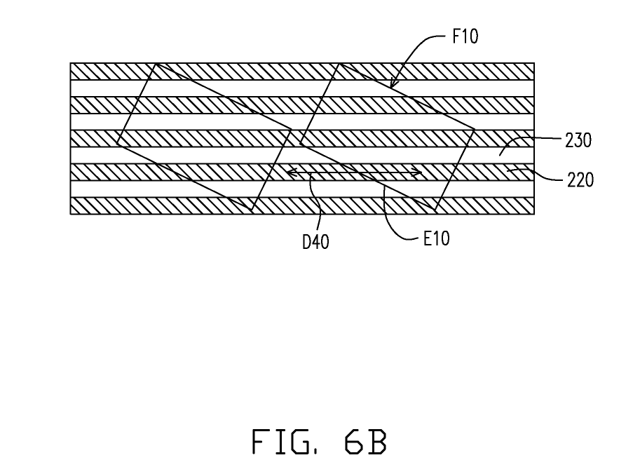

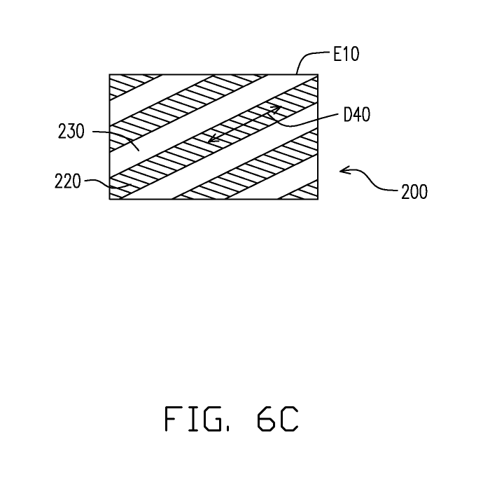

FIGS. 6A-6C are flowcharts illustrating the fabrication of a phase retardation film according to an embodiment of the disclosure. Referring to FIG. 6A, first, a plurality of stripe-shaped first regions 220 and a plurality of stripe-shaped second regions 230 are formed on a carrier substrate 210 by using a phase retardation material. The carrier substrate 210, the first regions 220, and the second regions 230 can be mass produced through batch manufacturing to reduce the fabrication cost. The first regions 220 and the second regions 230 are parallel to each other and are alternatively arranged.

Then, referring to FIG. 6B, the carrier substrate 210 is cut along a frame F10. The frame F10 presents a rectangular shape, and a long axis D40 of one of the first regions 220 forms an acute angle with one side of the frame F10. Next, referring to FIG. 6C, a phase retardation film 200 is completed. The phase retardation film 200 presents a rectangular shape and has a plurality of stripe-shaped first regions 220 and a plurality of stripe-shaped second regions 230. The first regions 220 and the second regions 230 are parallel to each other and are alternatively arranged. A long axis D40 of one of the first regions 220 forms an acute angle with the side E10 of the rectangle. The first regions 220 and the second regions 230 of the phase retardation film 200 are similar to the first regions 220 and the second regions 230 in FIG. 2, and the acute angle formed by the long axis D40 and the side E10 of the rectangle is also similar to the acute angle θ in FIG. 2 (for example, tan⁻¹(1/2)), therefore will not be described herein.

In summary, embodiments of the disclosure provide a display device and a phase retardation film, and the arrangement direction of sub-pixel regions and the long axis of a phase retardation area form an acute angle. Such a design resolves the problem of stereoscopic image distortion at side viewing angles and offers optimal stereoscopic image display brightness. In addition, light-shielding triangular pixel storage capacitors may be adopted to further increase the aperture ratio of the display device.

It is to be understood, however, that even though numerous characteristics and advantages of the present embodiments have been set out in the foregoing description, together with details of the structures and functions of the embodiments, the disclosure is illustrative only; and that changes may be made in detail, especially in matters of shape, size and arrangement of parts within the principles of the disclosure to the full extent indicated by the broad general meaning of the terms in which the appended claims are expressed.

What is claimed is:

1. A display device, comprising:
a display module, having a plurality of sub-pixel regions, wherein the sub-pixel regions are arranged into an array along a first direction and a second direction, and the first direction is perpendicular to the second direction; and
a phase retardation layer, disposed at the display module, wherein the phase retardation layer has a plurality of first regions presenting stripe-shapes and a plurality of second regions presenting stripe-shapes, the first regions and the second regions are parallel to each other and are alternatively arranged, a long axis of one of the first regions forms an acute angle with the first direction, and the first regions and the second regions allow lights in different polarization states to pass through.

2. The display device according to claim 1, wherein each of the sub-pixel regions presents a square shape.

3. The display device according to claim 2, wherein the acute angle is between 10° and 45°.

4. The display device according to claim 3, wherein the acute angle is tan⁻¹(1/2).

5. The display device according to claim 1, wherein a phase retardation difference between the first regions and the second regions is π/2.

6. The display device according to claim 1, wherein each of the sub-pixel regions respectively has overlap regions with the first regions and the second regions, and a smaller one of the overlap regions between each of the sub-pixel regions and the first regions and the second regions is a triangular region, and the triangular regions are opaque.

7. The display device according to claim 6, wherein a pixel storage capacitor is disposed in each of the triangular regions.

8. The display device according to claim 6, wherein a black matrix layer is disposed in each of the triangular regions.

9. The display device according to claim 1, wherein the display module is a liquid crystal display (LCD) module, an organic electro-luminescence device (OELD) panel, an electrophoresis display module, or a plasma display panel.

10. A phase retardation film, presenting a shape of a rectangle, comprising a plurality of first regions presenting stripe-shapes and a plurality of second regions presenting stripe-shapes, wherein the first regions and the second regions are parallel to each other and are alternatively arranged, a long axis of one of the first regions forms an acute angle with one side of the rectangle, and the first regions and the second regions allow lights in different polarization states to pass through.

11. The phase retardation film according to claim 10, wherein the acute angle is between 10° and 45°.

12. The phase retardation film according to claim 11, wherein the acute angle is tan⁻¹(1/2).
